(19) United States
(12) Patent Application Publication
(10) Pub. No.: US 2015/0178775 A1
(43) Pub. Date: Jun. 25, 2015

(54) RECOMMENDING SEARCH BID PHRASES FOR MONETIZATION OF SHORT TEXT DOCUMENTS

(71) Applicant: YAHOO! INC., Sunnyvale, CA (US)

(72) Inventor: NAGARAJ KOTA, Bangalore (IN)

(21) Appl. No.: 14/138,634

(22) Filed: Dec. 23, 2013

(51) Int. Cl. G06Q 30/02; G06F 17/30

(52) U.S. Cl. CPC G06Q 30/0256; G06F 17/3097

(57) ABSTRACT

A system and method for recommending search bid phrases for monetization of short text documents. A dictionary source is used to look up topics related to a short text document. The topics are then reduced to a coherent set of topics and a candidate set of query terms related to the coherent set of topics is found. The candidate set of query terms is then ranked according to revenue metric and the query terms having the highest rank are recommended.

### BACKGROUND

1. Technical Field

The disclosed embodiments relate to systems and methods for monetizing short text documents, and more particularly, monetizing short text documents through the use of recommended search bid phrases,

2. Background

Internet advertising is a multibillion dollar industry and is growing at double digit rates in recent years. It is also the major revenue source for internet companies such as Yahoo!® that provide advertising networks that connect advertisers, publishers, and Internet users. As an intermediary, these companies are also referred to as advertiser brokers or providers. New and creative ways to attract attention of users to advertisements (“ads”) or to the sponsors of those advertisements help to grow the effectiveness of online advertising, and thus increases the growth of sponsored and organic advertising. Publishers partner with advertisers, or allow advertisements to be delivered to their web pages, to help pay for the published content, or for other marketing reasons.

Internet advertising is more effective when the content of the advertisements is related to an interest of the Internet user. For example, if a user is actively searching the internet for automobiles for sale, advertisements related to automobile sales will be more effective than a random advertisement. Or, if an Internet user is viewing a movie, advertisements related to the movie or the genre of the movie will be more effective than a random advertisement. When the publisher is providing the content, it is relatively easy to for an intermediary to determine what types of advertisements are related to the content and provide those advertisements, since the content is well known to the publisher. In other situations, the publisher may use third party content provided by a user. For example, a picture hosting site might contain user photos, but still provide advertisements to support the picture hosting site. Because the content of the pictures may be unknown to the publisher and therefore cannot be provided to an intermediary, the intermediary may have to select an advertisement at random. An advertisement related to content consumed by a user is more valuable to an advertiser than an advertisement chosen at random. Because the advertisement is of greater value to the advertiser, the advertiser is willing to pay more for the related advertisement compared to a random advertisement.

Most content types typically contain metadata that describe a feature of the content. However, the metadata is often of little use for selection of a related advertisement for numerous reasons. The metadata may be missing for some content, may be misspelled, have multiple definitions, may be inconsistent, or may have other shortcomings. For example, an image having a meta-tag such as “Rubicon” could refer to the Rubicon River in Italy, a trail in the Sierra Nevada mountains, a model of Jeep® automobile, or a point of no return. Going by this meta-tag, an advertisement might promote travel to Italy, outdoor gear, auto parts, or some other good or service.

It would be beneficial to be able to accurately determine keywords related to the content of a document given a short text description of the document. Furthermore, it would be beneficial to be able to recommend keywords that described the document while maximizing the value of the keywords.

### BRIEF SUMMARY

Embodiments of the invention include a computing system for recommending query terms for received short text documents. The computing system includes a dictionary data source, a module configured receive a set of terms describing a document, a module configured to determine topics associated with the set of terms and queries associated with the set of terms, a module configured to determine a coherent set of topics from among the determined topic, a module configured to determine a candidate set of query terms from among the plurality of query terms, a module configured to determine a revenue metric for each query term among the candidate set of query terms, a module configured to rank the candidate set of query terms according to the revenue metric, and a module configured to recommend the query terms with the highest rank according to the revenue metric. The dictionary data source includes data associating topics with query terms. The coherent set of topics are topics that are most related to the set of terms. The candidate set of query terms consists of query terms most related to the coherent set of topics.

Another embodiment of the invention is directed to a method for recommending query terms for short text documents. In the method a computing system receives a set of terms describing a document. A computing system then performs a lookup of each of the set of terms in a dictionary data source to determine topics related to each term and query terms related to each of the determined topics. A computing system then determines a coherent set of topics from among the determined topics, the coherent set of topics being topics that are most related to the set of terms. A computing system then determines a candidate set of query terms from among a plurality of query terms related to the coherent set of topics, the candidate set of query terms consisting of query terms most related to the coherent set of topics. A revenue metric is determined by a computing system for each query term among the candidate set of query terms. The candidate set of query terms are ranked by a computing system according to the revenue metric. The query terms with the highest rank according to the revenue metric are recommended by the computing system.

Another embodiment of the invention is directed to a non-transitory computer-readable storage medium comprising computer-executable instructions that, when executed by a computer having a processor and memory, recommends query terms for received short text documents. The query terms are recommended by receiving a set of terms describing a document, looking up each of the set of terms in a dictionary data source to determine topics related to each term and query terms related to each of the determined topics, determining a coherent set of topics from among the determined topics, the coherent set of topics being topics that are most related to the set of terms, determining a candidate set of query terms from among a plurality of query terms related to the coherent set of topics, the candidate set of query terms consisting of query terms most related to the coherent set of topics, determining a revenue metric for each query term among the candidate set of query terms, ranking the candidate set of query terms according to the revenue metric, and recommending the query terms with the highest rank according to the revenue metric.

### BRIEF DESCRIPTION OF THE DRAWINGS

FIG. 1 illustrates an exemplary embodiment of a network system suitable for practicing the invention.

FIG. 2 illustrates a schematic of a computing device suitable for practicing the invention.

FIG. 3 illustrates a method of recommending queries based on short text documents.

FIG. 4 illustrates a system for recommending queries based on short text documents.

### DETAILED DESCRIPTION OF THE DRAWINGS AND THE PRESENTLY PREFERRED EMBODIMENTS

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense,

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

By way of introduction, the disclosed embodiments relate to a system and methods for determining keywords based on short text documents, such as metadata. The system is able to recommend search bid phrases for monetizing short text documents. The system may generate accurate search based phrases based on the short text documents. The method finds keywords that are highly bidded in the search market place and that are also relevant to the short text documents. The key words provided by the system may be further in selecting text-ads, sponsored search results, and other marketing efforts. The system may also be used to create user segments with a specific search re-targeting or intent. Users of the system may create or consume these short text documents and be added to a segment based on advertiser specification which typically consists of a set of search query terms.

### Network

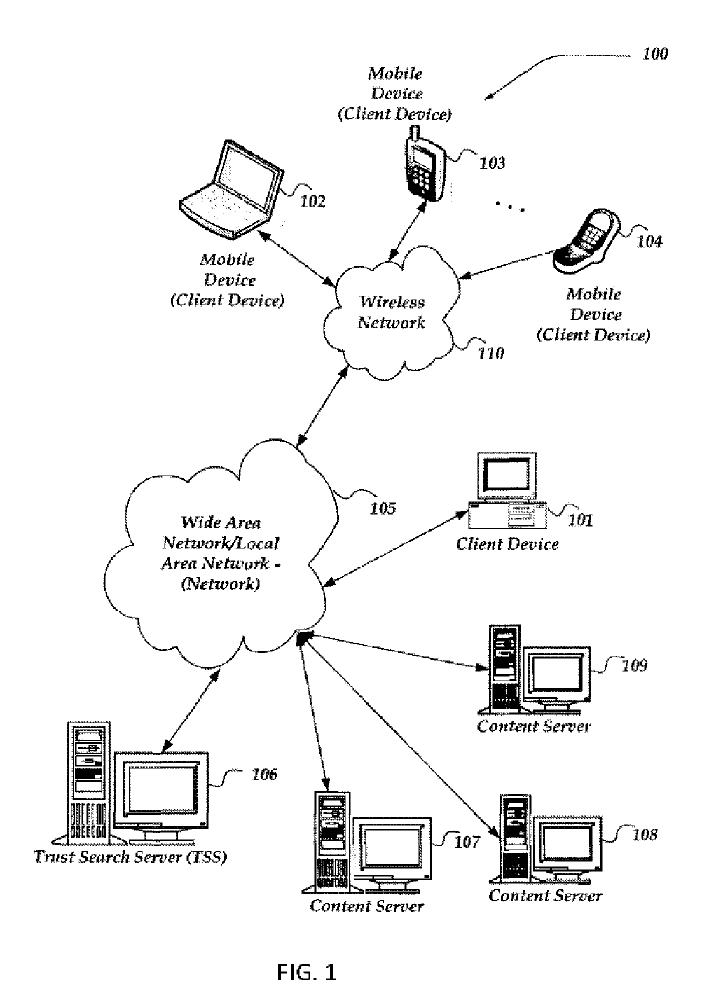

FIG. 1 is a schematic diagram illustrating an example embodiment of a network 100 suitable for practicing the claimed subject matter. Other embodiments may vary, for example, in terms of arrangement or in terms of type of components, and are also intended to be included within claimed subject matter. Furthermore, each component may be formed from multiple components. The example network 1000 of FIG. 1 includes a variety of networks, such as local area network (LAN)/wide area network (WAN) 105 and wireless network 110, interconnecting a variety of devices, such as client device 101, mobile devices 102, 103, and 104, servers 107, 108, and 109, and search server 106.

The network 100 may couple devices so that communications may be exchanged, such as between server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, or any combination thereof Likewise, sub-networks, such as may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

### Computing Device

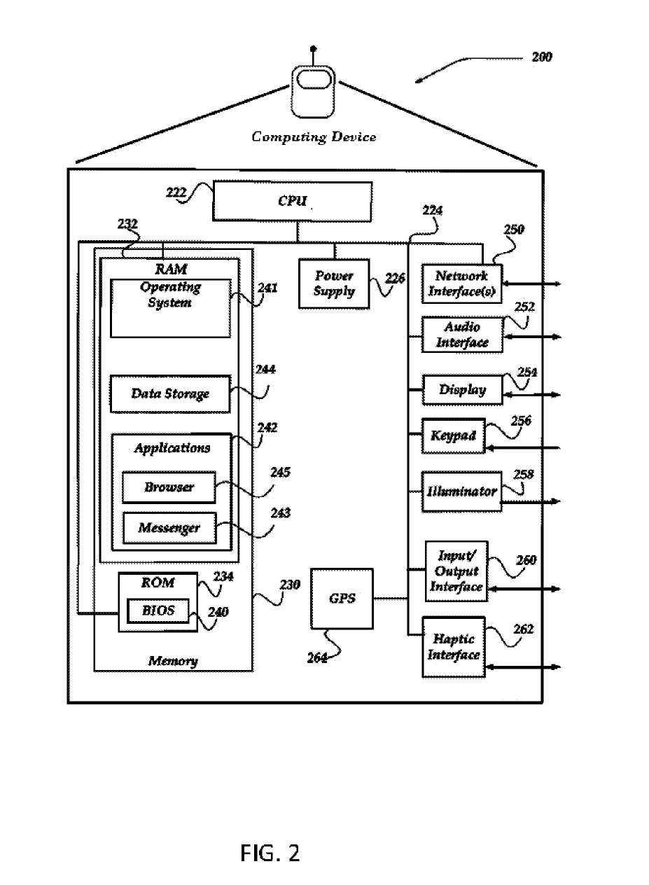

FIG. 2 shows one example schematic of embodiment of a computing device 200 that may be used to practice the claimed subject matter. The computing device 200 includes a memory 230 that stores computer readable data. The memory 230 may include random access memory (RAM) 232 and read only memory (ROM) 234. The ROM 234 may include memory storing a basic input output system (BIOS) 230 for interfacing with the hardware of the client device 200. The RAM 232 may include an operating system 241, data storage 244, and applications 242 including a browser 245 and a messenger 243. A central processing unit (CPU) 222 executes computer instructions to implement functions. A power supply 226 supplies power to the memory 230, CPU 222, and other components. The CPU 222, memory 230, and other devices may be interconnected by a bus 224 operable to communicate between the different components. The client device 200 may further include components interconnected to the bus 224 such as a network interface 250 that provides an interface between the client device and a network, an audio interface that provides auditory input and ouput with the client device, a display for displaying information, a keypad for inputing information, an illuminator for display visual indications, an input output interface for interfacing with other input and output devices, haptic feedback for providing tactile feedback, an a global positioning system for determining a geographical location.

### Client Device

A client device is a computing device 200 used by a client and may be capable of sending or receiving signals via the wired or the wireless network. A client device may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like.

A client device may vary in terms of capabilities or features and need not contain all of the components described above in relation to a computing device. Similarly, a client device may have other components that were not previously described. Claimed subject matter is intended to cover a wide range of potential variations. For example, a cell phone may include a numeric keypad or a display of limited functionality, such as a monochrome liquid crystal display (LCD) for displaying text. In contrast, however, as another example, a web-enabled client device may include one or more physical or virtual keyboards, mass storage, one or more accelerometers, one or more gyroscopes, global positioning system (GPS) or other location identifying type capability, or a display with a high degree of functionality, such as a touch-sensitive color 2D or 3D display, for example.

A client device may include or may execute a variety of operating systems, including a personal computer operating system, such as a Windows, iOS or Linux, or a mobile operating system, such as iOS, Android, or Windows Mobile, or the like. A client device may include or may execute a variety of possible applications, such as a client software application enabling communication with other devices, such as communicating one or more messages, such as via email, short message service (SMS), or multimedia message service (MMS), including via a network., such as a social network, including, for example, Facebook, LinkedIn, Twitter, Flickr, or Google+, to provide only a few possible examples. A client device may also include or execute an application to communicate content, such as, for example, textual content, multimedia content, or the like. A client device may also include or execute an application to perform a variety of possible tasks, such as browsing, searching, playing various forms of content, including locally stored or streamed. video, or games (such as fantasy sports leagues). The foregoing is provided to illustrate that claimed subject matter is intended to include a wide range of possible features or capabilities.

### Servers

A server is a computing device 200 that provides services. Servers vary in application and capabilities and need not contain all of the components of the exemplary computing device 200. Additionally, a server may contain additional components not shown in the exemplary computing device 200. In some embodiments a computing device 200 may operate as both a client device and a server.

Features of the claimed subject matter may be carried out by a content server. A content server may include a computing device 200 that includes a configuration to provide content via a network to another computing device. A content server may, for example, host a site, such as a social networking site, examples of Which may include, without limitation, Flicker, Twitter, Facebook, LinkedIn, or a personal user site (such as a blog, viog, online dating site, etc.). A content server may also host a variety of other sites, including, but not limited to business sites, educational sites, dictionary sites, encyclopedia sites, wikis, financial sites, government sites, etc. A content server may further provide a variety of services that include, but are not limited to, web services, third-party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example. Examples of devices that may operate as a content server include desktop computers, multiprocessor systems, microprocessor-type or programmable consumer electronics, etc.

### Searching

A search engine may enable a device, such as a client device, to search for files of interest using a search query. Typically, a search engine may be accessed by a client device via one or more servers. A search engine may, for example, in one illustrative embodiment, comprise a crawler component, an indexer component, an index storage component, a search component, a ranking component, a cache, a profile storage component, a logon component, a profile builder, and one or more application program interfaces (APIs). A search engine may be deployed in a distributed manner, such as via a set of distributed servers, for example. Components may be duplicated within a network, such as for redundancy or better access.

A crawler may be operable to communicate with a variety of content servers, typically via network. In some embodiments, a crawler starts with a list of URLs to visit. The list is called the seed list. As the crawler visits the URLs in the seed list, it identities all the hyperlinks in the page and adds them to a list of URLs to visit, called the crawl frontier. URLs from the crawler frontier are recursively visited according to a set of policies. A crawler typically retrieves files by generating a copy for storage, such as local cache storage. A cache refers to a persistent storage device. A crawler may likewise follow links, such as HTTP hyperlinks, in the retrieved file to additional files and may retrieve those files by generating copy for storage, and so forth. A crawler may therefore retrieve files from a plurality of content servers as it “crawls” across a network.

An indexer may be operable to generate an index of content, including associated contextual content, such as for one or more databases, which may be searched to locate content, including contextual content. An index may include index entries, wherein an index entry may be assigned a value referred to as a weight. An index entry may include a portion of the database. In some embodiments, an indexer may use an inverted index that stores a mapping from content to its locations in a database file, or in a document or a set of documents. A record level inverted index contains a list of references to documents for each word. A word level inverted index additionally contains the positions of each word within a document. A weight for an index entry may be assigned. For example, a weight, in one example embodiment may be assigned substantially in accordance with a difference between the number of records indexed without the index entry and the number of records indexed with the index entry.

The term “Boolean search engine” refers to a search engine capable of parsing Boolean-style syntax, such as may be used in a search query. A Boolean search engine may allow the use of Boolean operators (such as AND, OR, NOT, or XOR) to specify a logical relationship between search terms. For example, the search query “college OR university” may return results with “college,” results with “university,” or results with both, while the search query “college XOR university” may return results with “college” or results with “university,” but not results with both,

In contrast to Boolean-style syntax, “semantic search” refers a search technique in which search results are evaluated for relevance based at least in part on contextual meaning associated with query search terms. In contrast with Boolean-style syntax to specify a relationship between search terms, a semantic search may attempt to infer a meaning for terms of a natural language search query. Semantic search may therefore employ “semantics” (e.g., science of meaning in language) to search repositories of various types of content.

Search results located during a search of an index performed in response to a search query submission may typically be ranked. An index may include entries with an index entry assigned a value referred to as a weight. A search query may comprise search query terms, wherein a query term may correspond to an index entry. In an embodiment, search results may be ranked by scoring located files or records, for example, such as in accordance with number of times a query term occurs weighed in accordance with a weight assigned to an index entry corresponding to the query term. Other aspects may also affect ranking, such as, for example, proximity of query terms within a located record or file, or semantic usage, for example. A score and an identifier for a located record or file, for example, may be stored in a respective entry of a ranking list. A list of search results may be ranked in accordance with scores, which may, for example, be provided in response to a search query. In some embodiments, machine-learned ranking (MLR) models are used to rank search results. MLR is a type of supervised or semi-supervised machine learning problem with the goal to automatically construct a ranking model from train.

Content within a repository of media or multimedia, for example, may be annotated. Examples of content may include text, images, audio, video, or the like, which may be processed in the form of physical signals, such as electrical signals, for example, or may be stored in memory, as physical states, for example. Content may be contained within an object, such as a Web object, Web page, Web site, electronic document, or the like. An item in a collection of content may be referred to as an “item of content” or a “content item,” and may be retrieved from a “Web of Objects” comprising objects made up of a variety of types of content. The term “annotation,” as used herein, refers to descriptive or contextual content related to a content item, for example, collected from an individual, such as a user, and stored in association with the individual or the content item. Annotations may include various fields of descriptive content, such as a rating of a document, a list of keywords identifying topics of a document, etc.ing data.

### Social Networks

The term “social network” refers generally to a network of individuals, such as acquaintances, friends, family, colleagues, or co-workers, coupled via a communications network or via a variety of sub-networks. Potentially, additional relationships may subsequently be formed as a result of social interaction via the communications network or sub-networks. A social network may be employed, for example, to identify additional connections for a variety of activities, including, but not limited to, dating, job networking, receiving or providing service referrals, content sharing, creating new associations, maintaining existing associations, identifying potential activity partners, performing or supporting commercial transactions, or the like.

A social network may include individuals with similar experiences, opinions, education levels or backgrounds. Subgroups may exist or be created according to user profiles of individuals, for example, in which a subgroup member may belong to multiple subgroups. An individual may also have multiple “1:few” associations within a social network, such as for family, college classmates, or co-workers. An individual's social network may refer to a set of direct personal relationships or a set of indirect personal relationships. A direct personal relationship refers to a relationship for an individual in which communications may be individual to individual, such as with family members, friends, colleagues, co-workers, or the like. An indirect personal relationship refers to a relationship that may be available to an individual with another individual although no form of individual to Individual communication may have taken place, such as a friend of a friend, or the like. Different privileges or permissions may be associated with relationships in a social network. A social network also may generate relationships or connections with entities other than a person, such as companies, brands, or so called ‘virtual persons.’ An individual's social network may be represented in a variety of forms, such as visually, electronically or functionally. For example, a “social graph” or “socio-gram” may represent an entity in a social network as a node and a relationship as an edge or a link.

### Overview

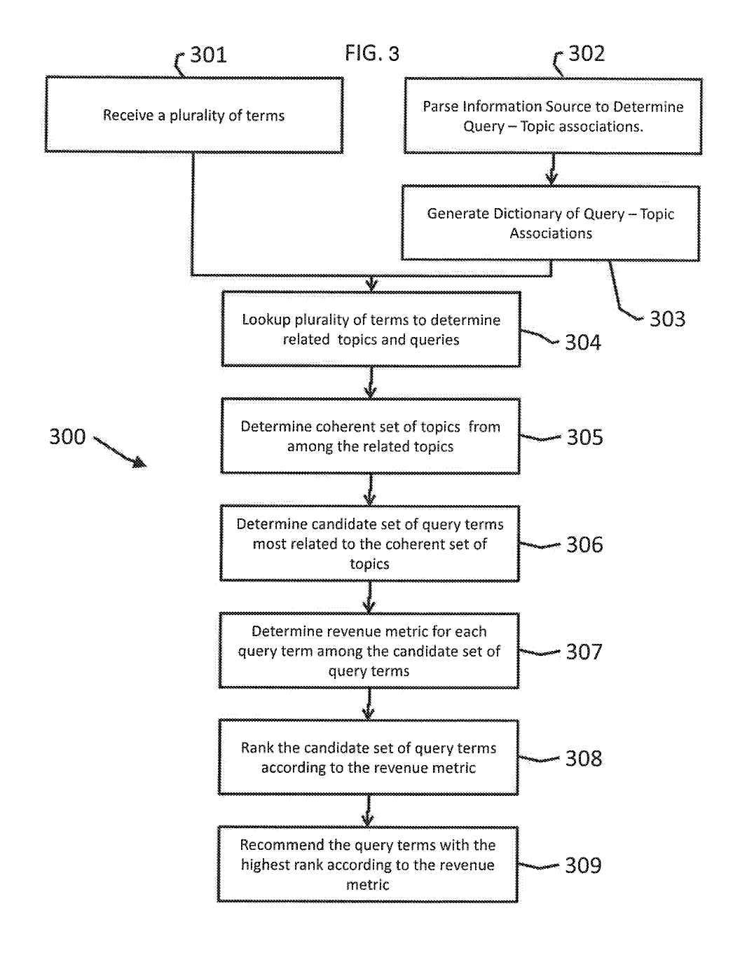

FIG. 3 illustrates a high level flowchart of a method 300 for generating search terms from short text documents. The steps shown in the flowchart are executed by a computing device and each step may be performed by a separate software component of a computing device, or the execution of steps may be combined in one or more software components. The software components may exist on separate computing devices connected by a network, or they may exist on a single computing device. Computer executable instructions for causing the computing device to perform the steps may be stored on a non-transitory computer readable storage medium in communication with a processor.

In box 301 a plurality of terms is received. The plurality of terms describes a document such an image, a video, an audio clip, or other media. The plurality of terms may be received by a server. For example, a client device may send a plurality of terms describing an image to a server over a network. In another example, a crawler may send a plurality of terms describing a video document to a server.

In box 302 an information source is parsed to determine query-topic associations. The information source may be parsed by a computing device such as a crawler or a server. Suitable information sources include logs, databases, web sites, and other data sources. When a search query is sent by a user to a search engine, the search engine generates a results page containing links to websites that are relevant to the search query. The links may point to the topics as well as other websites. The search queries are typically logged in a search query log that may identify incoming search queries, the link results of a search, and the links that were followed by a user.

In one embodiment, a search query log is parsed to find link results that point to a topic source. One example of an exemplary source for topics is an encyclopedia web site. An encyclopedia web site provides a summary of information for a given topic and is typically indexed by topics. An exemplary online encyclopedia is Wikipedia, which is readily indexed by search engines. For example, a search log may be parsed to find all incoming queries that had search results leading to the Wikipedia website.

Each query may be linked to the topic that the query result links to. In some embodiments, a query will only be linked to a topic if a threshold number of users select the query result link, in addition to associating the query to the topic, other information may be found from the search log. For instance, the frequency at which queries are used in combination with one another, the frequency that a search result is selected by a user, and other features may be determined from the search log. If it is determined that a threshold number of users have selected the link to the topic, the query is associated with the topic.

In another embodiment, a crawler analyzes web pages that link to the topic source. In particular, the anchor text of the link to the topic source of interest may be associated with a topic the link points to. Using the example of an online encyclopedia, a webpage may have a link to an encyclopedia topic for the New Orleans Pelicans. The link, rather than displaying the hypertext to the address of the encyclopedia topic, may have an anchor text of “Pelicans.” The query term “Pelicans” device would then associated with the topic “New Orleans Pelicans”.

The query-topic associations may be found using these techniques individually or in combination. Additionally, other techniques for determining query topic associates are possible and are within the scope of the claimed embodiment provided that they associate query terms to a topic.

In box 303 a dictionary is generated from the topic-query associations determined in box 302. The dictionary may be generated by a dedicated dictionary device, or the functionality may be combined with other components such as the information source parser, a dedicated server, a search engine, a web crawler, an indexer, or other computing device. The dictionary is a data structure that links topics and associated queries, along with related features including commonness, key-phraseness, and link-probability.

In box 304 a lookup is performed in the dictionary generated in box 303 for the received plurality of terms to determine topics and queries associated with each of the terms. For each term, there may be at least one associated topic and at least one query associated with the associated topic. For example, the term “Pelicans” may lead to a topic of both “birds” and the “New Orleans Pelicans” basketball team. For each of these topics, there is at least one query that is associated with the topic. For example, the topic “New Orleans Pelicans” may have associated queries including Pelicans, National, Basketball, Association, New, and Orleans. Therefore an incoming search term of Pelican would return the topics “birds” and “New Orleans Pelicans” and the queries Pelicans, National, Basketball, Association, New, and Orleans.

In box 305 a coherent set of topics is determined from among the related topics found in box 304. The coherent set of topics are the topics that are most related to the set of terms. In one embodiment, a coherent set of topics is determined through the use of a graph. The graph is constructed using each of the determined topics as a topic node and each of terms as term nodes. Edges are formed between the term nodes based on a co-occurrence similarity metric. For example, terms that are often grouped together would have an edge to one another with a higher metric than a group of terms only occasionally used together. Edges are formed between the term nodes and the topic nodes based on a topic resolution metric, such as how likely a given term will lead to an associated topic relative to the other terms. This graph is then initialized with the term nodes having a uniform distribution and the topic nodes having a zero vector. A page rank is then performed to score each of the topic nodes. The topic nodes have the highest page rank are determined to have the topics most related to the set of terms.

The topics most related to the set of terms forms the coherent set of topics. The number of topics within the coherent set is an adjustable number and can be changed as necessary. For example, in an embodiment in which the number of topics in the coherent set is four, the four topics receiving the highest page rank in the box 305 will form the coherent set. The higher the number of topics the greater chance there is that one of the topics will have little relation to the search terms, while with a lower number of topics there will be a greater chance that a topic closely related to the search term may be excluded from the coherent set.

In box 306 a candidate set of query terms is determined. The candidate set of query terms are those terms that are most related to the coherent set of topics. The candidate set of query terms may include terms from the original plurality of terms but does not need to. In one embodiment the candidate set of query terms is determined through the use of a second graph. The graph comprises the coherent set of topics as topic nodes, the plurality of query terms related to the coherent set of topics as query nodes, topic to query edges between topic nodes and connected query nodes, topic to topic edges based on relatedness of topics, and query to query edges based on queries being a part of a common search. The relatedness of topics and the queries being part of a common search can be determined using the features stored in the dictionary as described previously. Once the graph is constructed the topic nodes are initialized with a normalized PageRank score and the query nodes are initialized with a zero vector. A page rank is then performed on the graph to determine a page rank score for each of the query nodes. The query nodes with the highest page rank are those that are most related to the coherent set of topics.

In box 307 a revenue metric is determined for each of the query terms. The revenue metric may be determined for just the query terms in the candidate set, or in some embodiments, a revenue metric may be determine for the query terms prior to finding the candidate set. In one embodiment the revenue metric is based on normalized revenue per search. The normalized revenue per search can be found using the revenue per search and normalized it based on the frequency of searches of a query term.

In box 308 the candidate set of query terms is ranked according to the revenue metric. This ranking can be performed using the graph described in relation to box 306, but with the nodes corresponding to the candidate set of query terms having a distribution based on the revenue metric and the remaining nodes initialized using a zero vector. A page rank is then performed on the graph and the queries are ranked according to their page rank. In box 309, the highest ranked queries are recommended. In one embodiment, the number of recommended queries is equal to the number of terms from among the plurality of terms. In other embodiments the number of recommended queries may be greater than the number of terms or less than the number of terms.

In box 306 a graph is constructed with each of the candidate topics as a node and each of the plurality of terms as a node. Edges are formed based on term-term, topic ID-topic ID, and term-topic ID interactions. There is an edge between two term nodes if the second term follows the first term with a high likelihood.

### Example Method

An example of the method 300 will now be described using a simplified set of data. For this example it is assumed that a search log has been parsed to determine queries and their relation to topics. It will further be assumed that the topic source is Wikipedia and each topic corresponds to a Wikipedia entry. Initially consider the case where there are four images with associated tags:

I1={hornet, queen, vespa crabro,s e26};

I2={moto, hornet, honda, blu, blue, bike};

I3={basketball, hornets, nba, okc thunder, serge ibaka};

I4={blue angels 2009, Jacksonville beach, Florida, blue angels, us navy, military, air show, fa18a hornets, aircraft}.

Each of these images has the tag “hornet” in common, but each with a different interpretation. For example, in I1 the tag “hornet” corresponds to an insect, in I2 the tag corresponds to a motorcycle, in I3 the tag corresponds to a basketball team, and in I4 the tag corresponds to an aircraft.

Using I3 as an example, the terms basketball, hornets, nba, okc thunder, and serge ibaka are looked up in the dictionary to find associated topics. An example of topics returned might include Seattle SuperSonics, Serge Ibaka, National Basketball Association, Oklahoma City Thunder, New Orleans Pelicans, Republic of the Congo, and Spain. Of these topics, the coherent set containing the topics most related to the set of terms is found in this instance, the top three topics may be determined to be the coherent set. The coherent set sorted by their relevance to the set of terms may be Serge ibaka, Oklahoma City Thunder, and National Basketball Association.

A candidate set of query terms would then be determined for this coherent set of topics. The dictionary lookup may have determined a large number of query terms leading to these topics but the candidate set will contain only those that are most related. For example, terms like players, roster, teammate, hoops, basketball, tall, athlete, fashion, apparel, tickets, and dunk might all be query terms determined to be relevant in the dictionary lookup. The candidate set of query terms is the most relevant of these terms and might include the terms basketball, thunder, tickets, Oklahoma, fashion, apparel, and dunk. In this example the terms players, roster, teammate, hoops, tall, athlete, and fashion are not a part of the candidate set since they are not as related to the coherent set of topics.

A value is determined for each of the query terms in the candidate set based on how much revenue each term generates per search and the number of times the term is searched. The terms are then ranked according to their value. In this example the terms might be ranked in this order tickets, apparel, Thunder, Oklahoma, basketball, fashion, and dunk. The top terms are then recommended which might include the terms tickets, apparel, and Thunder.

This method is advantageous in that it provides for keywords that are both relevant to the original set of keywords, but are also of high value. The original set of terms have little vale as key words since they may be inaccurate on their own and/or they may be terms that do not have a high revenue per search in this method the keywords most related to the set of terms and having the highest value are found. The keywords are more likely to accurately describe the document represented by the set of terms than any one of the individual terms. This method recommends other terms that might be less relevant, but that are more likely to be highly bidded in the search marketplace. Thus we are able to obtain keywords that are both relevant and highly bidded.

### Example System

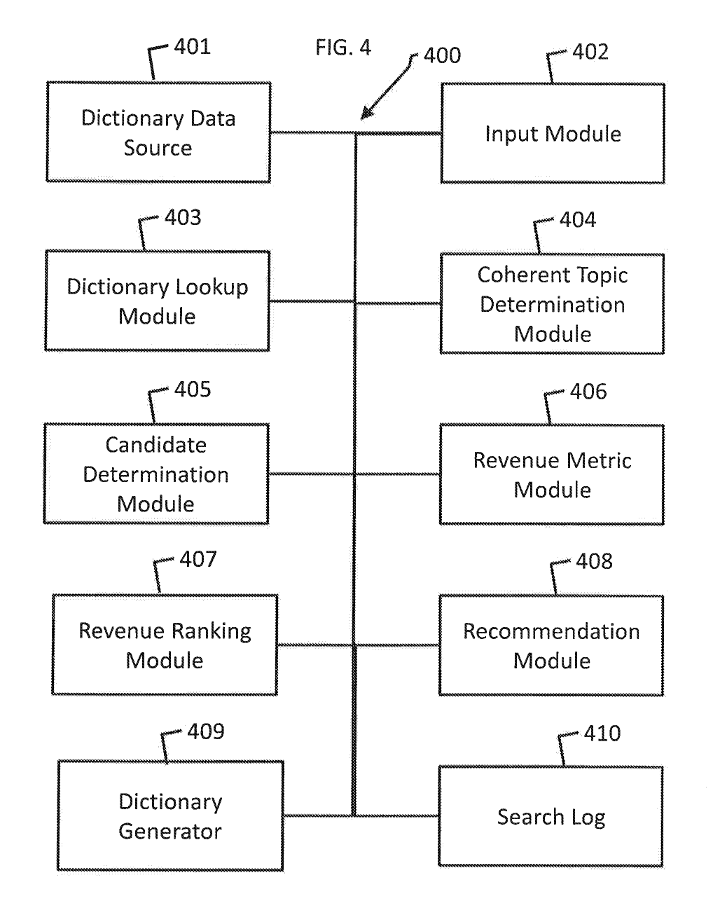

FIG. 4 illustrates a schematic of a system 400 for generating keywords from short text documents. The system 400 may be executed as hardware or software modules on a computing device as shown in FIG. 2, or as a combination of hardware and software modules. The modules may be executable on a single computing device or a combination of modules may each be executable on separate computing devices interconnected by a network. FIG. 4 illustrates the system 400 as each component being connected by a common communication channel, but it need not be. For example, the different components may connect directly to another component and skip the common communication channel.

A dictionary data source 401 is configured to store data associating topics with query terms. An input module 402 is configured to receive a set of keywords. The input module 402 is communicatively coupled to the dictionary data source and to a dictionary look up module 403. The dictionary look up module 403 is configured to look up the set of terms in the dictionary data source 401 to determine topics and queries associated with the set of terms.

The dictionary look-up module 403 is communicatively coupled to a coherent topic determination module 404. The coherent topic determination module 404 is configured to determine a coherent set of topics from among the topics determined by the dictionary lookup module 403 using the techniques described previously.

A candidate determination module 405 is communicatively coupled to the coherent topic determination module 404 and is configured to receive the coherent set of topics from the coherent topic determination module 404. The candidate determination module 405 is further configured to determine a candidate set of query terms from among the plurality of query terms determined to be related to the set of terms. The candidate set of query terms consists of the terms determined to be most related to the coherent set of topics.

The candidate determination module 405 is communicatively coupled to a revenue metric module 406. The revenue metric module 406 is configured to determine a revenue metric for each query term among the candidate set of query terms. A revenue ranking module 407 communicatively coupled to the revenue metric module 406 is configured to rank the candidate set of query terms according to the revenue metric. A recommendation module 408 is communicatively coupled to the revenue ranking module 406 and is configured to recommend the query terms with the highest rank according to the revenue metric.

The system may further include a dictionary generator module 409 configured to analyze a search log to determine query terms resulting in links to topics and to build the dictionary data source 401 by associating the query terms with the topics. In some embodiments the dictionary generator module 409 may be further configured to analyze an anchor text of a website to determine anchor text leading to topic and build the dictionary data source 401 by associating the anchor text as a query term with the topic. The system may further comprise a search log 410 containing a history of query terms and search results.

Form the foregoing, it can be seen that the present disclosure provides systems and methods for accurately recommending keywords based on a short text document. The keywords are relevant to media that the short text document is describing, while also providing keywords that are highly bidded in the advertising marketplace. Thus the system and methods allow an advertising broker to maximize revenue by selling highly bidded search terms while ensuring that the displayed ads are relevant to the media.

While various embodiments have been described above, it should be understood that they have been presented by way of example only, and not limitation. It will be apparent to persons skilled in the relevant arts) that various changes in form and details can be made therein without departing from the spirit and scope of the invention. Thus, the breadth and scope of the present invention should not be limited by any of the above-described exemplary embodiments, but should be defined only in accordance with the following claims and their equivalents.

1. A computing system for recommending query terms for received short text documents comprising:
a dictionary data source comprising data associating topics with query terms;
a module configured receive a set of terms describing a document;
a module configured to determine topics associated with the set of terms and queries associated with the set of terms;
a module configured to determine a coherent set of topics from among the determined topics, the coherent set of topics being topics that are most related to the set of terms;
a module configured to determine a candidate set of query terms from among the plurality of query terms, the candidate set of query terms consisting of query terms most related to the coherent set of topics;
a module configured to determine a revenue metric for each query term among the candidate set of query terms;
a module configured to rank the candidate set of query terms according to the revenue metric; and
a module configured to recommend the query terms with the highest rank according to the revenue metric.

2. The system of claim 1 further comprising a dictionary generator module configured to analyze a search log to determine query terms leading to topics and build the dictionary data source by associating the query terms with topics that the query term leads to.

3. The system of claim 2 wherein the dictionary generator further analyzes an anchor text of a website to determine anchor text leading to topic and builds the dictionary data source by associating the anchor text as a query term with the topic the anchor text leads to.

4. The system of claim 3 further comprising a search log accessible containing a history of query terms and search results.

5. A method for recommending query terms for short text documents, the method comprising;
receiving by a computing system a set of terms describing a document;
performing by a by a computing system a lookup for each of the set of terms in a dictionary data source to determine topics related to each term and query terms related to each of the determined topics;
determining by a computing system a coherent set of topics from among the determined topics, the coherent set of topics being topics that are most related to the set of terms;
determining by a computing system a candidate set of query terms from among a plurality of query terms related to the coherent set of topics, the candidate set of query terms consisting of query terms most related to the coherent set of topics;
determining by a computing system a revenue metric for each query term among the candidate set of query terms;
ranking by a computing system the candidate set of query terms according to the revenue metric; and
recommending by a computing system the query terms with the highest rank according to the revenue metric.

6. The method of claim 5 wherein determining a coherent set of topics comprises:
building by a computing system a graph comprising topic nodes corresponding to the determined topics, term nodes corresponding to each term of the received set of terms, edges between the term nodes based on a co-occurrence similarity metric, and edges between the term nodes and the topic nodes based on a topic resolution metric;
initializing by a computing system the term nodes with a uniform distribution;
initializing by a computing system the topic nodes with a zero vector; and
performing by a computing system a page rank on the graph to determine a page rank score for each of the topic nodes, wherein the topic nodes with the highest page rank are most related to the set of terms.

7. The method of claim 5 wherein determining a candidate set of query terms comprises:
building by a computing system a graph comprising the coherent set of topics as topic nodes, the plurality of query terms related to the coherent set of topics as query nodes, topic to query edges between topic nodes and connected query nodes, topic to topic edges based on relatedness of topics, and query to query edges based on queries being a part of a common search;
initializing by a computing system the topic nodes with a normalized PageRank score;
initializing by a computing system the query nodes with a zero vector; and
performing by a computing system a page rank on the graph to determine a page rank score for each of the query nodes, wherein the query nodes with the highest page rank are most related to the coherent set of topics.

8. The method of claim 5 wherein determining a revenue metric comprises:
computing by a computing system a revenue per search for a query term from among the candidate set of query terms;
determining by a computing system the frequency of searches of the query term from among the candidate set of query terms; and
normalizing by a computing system the revenue of the query term from among the candidate set of query terms.

9. The method of claim 7 wherein ranking the candidate set of query terms comprises:
initializing by a computing system the graph with the nodes corresponding to the candidate set of query terms having a distribution based on the revenue metric and the remaining nodes initialized to a zero vector;
performing by a computing system a page rank on the graph to determine a page rank score for each of the nodes to determine a rank for each of the nodes.

10. The method of claim 5 further comprising:
analyzing by a computing system a search log to determine query terms and resulting topics;
building by a computing system the dictionary data source by associating the query terms with the resulting topics.

11. The method of claim 5 wherein a total number of recommended query terms is equal to the total number of the terms of the received set of terms.

12. The method of claim 5 wherein each of the topics is an online encyclopedia topic.

13. The method of claim 12 wherein the online encyclopedia is a user community managed website.

14. A non-transitory computer-readable storage medium comprising computer-executable instructions that, when executed by a computer having a processor and memory, recommends query terms for received short text documents by:
receiving a set of terms describing a document;
looking up each of the set of terms in a dictionary data source to determine topics related to each term and query terms related to each of the determined topics;
determining a coherent set of topics from among the determined topics, the coherent set of topics being topics that are most related to the set of terms;
determining a candidate set of query terms from among a plurality of query terms related to the coherent set of topics, the candidate set of query terms consisting of query terms most related to the coherent set of topics;
determining a revenue metric for each query term among the candidate set of query terms;
ranking the candidate set of query terms according to the revenue metric; and
recommending the query terms with the highest rank according to the revenue metric.

15. The non-transitory computer-readable storage medium of claim 14 wherein determining a coherent set of topics comprises:
building a graph comprising topic nodes corresponding to the determined topics, term nodes corresponding to each term of the received set of terms, edges between the term nodes based on a co-occurrence similarity metric, and edges between the term nodes and the topic nodes based on a topic resolution metric;
initializing the term nodes with a uniform distribution;
initializing the topic nodes with a zero vector; and
performing a page rank on the graph to determine a page rank score for each of the topic nodes, wherein the topic nodes with the highest page rank are most related to the set of terms.

16. The non-transitory computer-readable storage medium of claim 14 wherein determining a candidate set of query terms comprises:
building a graph comprising the coherent set of topics as topic nodes, the plurality of query terms related to the coherent set of topics as query nodes, topic to query edges between topic nodes and connected query nodes, topic to topic edges based on relatedness of topics, and query to query edges based on queries being a part of a common search;
initializing the topic nodes with a normalized PageRank score;
initializing the query nodes with a zero vector; and
performing a page rank on the graph to determine a page rank score for each of the query nodes, wherein the query nodes with the highest page rank are most related to the coherent set of topics.

17. The non-transitory computer-readable storage medium of claim 14 wherein determining a revenue metric comprises:
computing a revenue per search for a query term from among the candidate set of query terms;
determining the frequency of searches of the query term from among the candidate set of query terms; and
normalizing the revenue of the query term from among the candidate set of query

18. The non-transitory computer-readable storage medium of claim 13 wherein the instruction further recommend query terms by:
analyzing a search log to determine query terms and resulting topics; and
building the dictionary data source by associating the query terms with the resulting topics,

19. The non-transitory computer-readable storage medium of claim 18 wherein the instruction further recommend query terms by:
analyzing anchor text of a website to determine anchor text leading to topic; and
building the dictionary data source by associating the anchor text as a query term with the topic the anchor text leads to.

20. The non-transitory computer-readable storage medium of claim 14 wherein a total number of recommended query terms is equal to the total number of the terms of the received set of terms.

21. The non-transitory computer-readable storage medium of claim 14 wherein each of the topics is an online encyclopedia topic.

22. The non-transitory computer-readable storage medium of claim 21 wherein the online encyclopedia is a user community managed website.
